(19) United States
(12) Patent Application Publication
(10) Pub. No.: US 2025/0392150 A1
(43) Pub. Date: Dec. 25, 2025

(54) Charging method, corresponding charging device and various corresponding uninterruptible power systems

(71) Applicant: CYBER POWER SYSTEMS, INC, TAIPEI CITY (TW)

(72) Inventors: SHOU-TING YEH, TAIPEI CITY (TW); KAI-TSUNG YANG, TAIPEI CITY (TW); CHAO-CHING YANG, TAIPEI CITY (TW)

(21) Appl. No.: 18/829,425

(22) Filed: Sep. 10, 2024

(30) Foreign Application Priority Data
Jun. 24, 2024 (CN) 2024108157546

(51) Int. Cl. H02J 7/00; H01M 50/51

(52) U.S. Cl. CPC H02J 7/007182; H01M 50/51; H02J 7/0014; H02J 7/00302; H02J 2207/20

(57) ABSTRACT

A charging method, a corresponding charging device and various corresponding uninterruptible power systems are provided. The method comprises: controlling a charging circuit to charge a battery string and measuring a voltage of each battery; determining whether a start condition for performing a voltage balancing operation is met based on the voltage values of the batteries, and determining whether the voltage value of any battery is greater than or equal to a first threshold value; whenever the start condition is met, controlling a battery balancing circuit to start performing the voltage balancing operation until the voltage values of the batteries meet an end condition of the voltage balancing operation; and whenever the voltage value of any battery is greater than or equal to the first threshold value, reducing the output energy of the charging circuit until the voltage value of any battery is less than the first threshold value.

### BACKGROUND OF THE INVENTION

### Field of the Invention

The present invention relates to the technical field of battery charging, and in particular, to a charging method, a corresponding charging device and various corresponding uninterruptible power systems.

### Description of Related Art

Generally speaking, when charging a battery string, it is very likely that the battery voltage will be unbalanced. Although there are many reasons for battery voltage unbalance, regardless of the cause, once battery voltage unbalance occurs, it is easy to cause some batteries to be overcharged. Once a battery is overcharged, the life of the overcharged battery is extremely easy to be reduced or even damaged (such as visible swelling in appearance).

### SUMMARY OF THE INVENTION

An object of the present invention is to provide a charging method, which can prevent batteries from overcharging.

Another object of the present invention is to provide a charging device using the aforementioned charging method.

Still another object of the present invention is to provide an on-line uninterruptible power system adopting the aforementioned charging device.

Still another object of the present invention is to provide an off-line uninterruptible power system adopting the aforementioned charging device.

Still another object of the present invention is to provide a line-interactive uninterruptible power system adopting the aforementioned charging device.

To achieve the above object, the present invention provides a charging method, which is suitable for a battery string consisting of batteries connected in series. The charging method comprises the following steps: controlling a charging circuit to charge the battery string and measuring a voltage of each battery; determining whether a start condition for performing a voltage balancing operation is met based on the voltage values of the batteries, and determine whether the voltage value of any battery is greater than or equal to a first threshold value; whenever the start condition is met, controlling a battery balancing circuit to start performing the voltage balancing operation on the battery string until the voltage values of the batteries meet an end condition of the voltage balancing operation; and whenever it is determined that the voltage value of any battery is greater than or equal to the first threshold value, reducing the output energy of the charging circuit until the voltage value of any battery is less than the first threshold value.

To achieve the above another object, the present invention provides a charging device for charging a battery string consisting of batteries connected in series. The charging device comprises a charging circuit, a battery balancing circuit and a control circuit. The charging circuit is electrically coupled to two terminals of the battery string. The battery balancing circuit is electrically coupled to the two terminals of each battery for measuring a voltage of each battery and performing a voltage balancing operation on the battery string. The control circuit is also used to determine whether a start condition for performing the voltage balancing operation is met based on the voltage values of the batteries, and to determine whether the voltage value of any battery is greater than or equal to a first threshold value. Whenever the start condition is met, the control circuit controls the battery balancing circuit to start performing the voltage balancing operation on the battery string until the voltage values of the batteries meet an end condition of the voltage balancing operation, and whenever it is determined that the voltage value of any battery is greater than or equal to the first threshold value, the control circuit reduces the output energy of the charging circuit until the voltage value of any battery is less than the first threshold value.

In order to make the above objects, technical features and gains after actual implementation more obvious and easy to understand, in the following, the preferred embodiments will be described with reference to the corresponding drawings and will be described in more detail.

### BRIEF DESCRIPTION OF THE DRAWINGS

Other features and advantages of the present invention will become apparent in the following detailed description of the preferred embodiments with reference to the accompanying drawings, of which:

FIG. 1 shows an uninterruptible power system according to an embodiment of the present invention.

FIG. 2 shows the electrical coupling relationship between the charging device and the battery pack 106.

FIG. 3 is a flow chart of a charging method according to an embodiment of the present invention.

FIG. 4 is used to illustrate one of the charging processes of the aforementioned battery string.

FIG. 5 shows an uninterruptible power system according to another embodiment of the present invention.

FIG. 6 shows an uninterruptible power system according to still another embodiment of the present invention.

FIG. 7 shows an uninterruptible power system according to still another embodiment of the present invention.

FIG. 8 shows an uninterruptible power system according to still another embodiment of the present invention.

### DESCRIPTION OF EMBODIMENTS

The characteristics, contents, advantages and achieved effects of the present disclosure will become more fully understood from the detailed description given herein below and the accompanying drawings which are given by way of illustration only, and thus are not limitative of the present disclosure.

As required, detailed embodiments are disclosed herein. It must be understood that the disclosed embodiments are merely exemplary of and may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

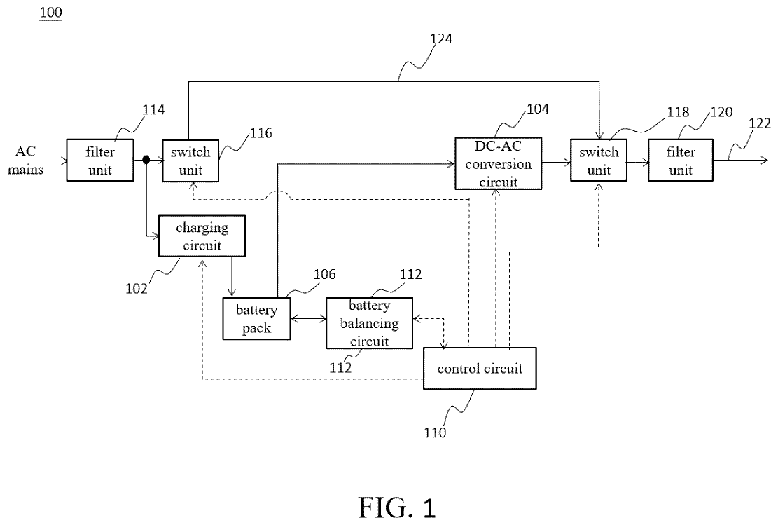

FIG. 1 shows an uninterruptible power system according to an embodiment of the present invention. Please refer to FIG. 1. From the circuit structure shown in FIG. 1, it can be seen that the uninterruptible power system 100 is an off-line uninterruptible power system (Off-line UPS). The uninterruptible power system 100 comprises a filter unit 114, a switch unit 116, a DC-AC conversion circuit 104, a switch unit 118, a filter unit 120, a charging circuit 102, a battery pack 106, a battery balancing circuit 112, a control circuit 110 and a bypass path 124.

The switch unit 116 is electrically coupled to one terminal of the bypass path 124, and is electrically coupled to the AC power source (e.g., AC mains) through the filter unit 114. The switch unit 118 is electrically coupled to the other terminal of the bypass path 124, and is electrically coupled to an output end 122 of the uninterruptible power system 100 through the filter unit 120. The charging circuit 102 is electrically coupled to the battery pack 106, and is electrically coupled to the AC power source through the filter unit 114. The DC-AC conversion circuit 104 is electrically coupled between the battery pack 106 and the switch unit 118. The battery balancing circuit 112 is electrically coupled to the battery pack 106.

In addition, the switch unit 116, the DC-AC conversion circuit 104, the switch unit 118, the charging circuit 102 and the battery balancing circuit 112 are electrically coupled to the control circuit 110 to be controlled by the control circuit 110. For example, the control circuit 110 can control the operation of the switch unit 118, so as to determine whether to electrically couple the output terminal of the DC-AC conversion circuit 104 to the filter unit 120, or to electrically couple the bypass path 124 to the filter unit 120. In addition, the charging circuit 102, the battery balancing circuit 112 and the control circuit 110 make up the charging device of the present invention.

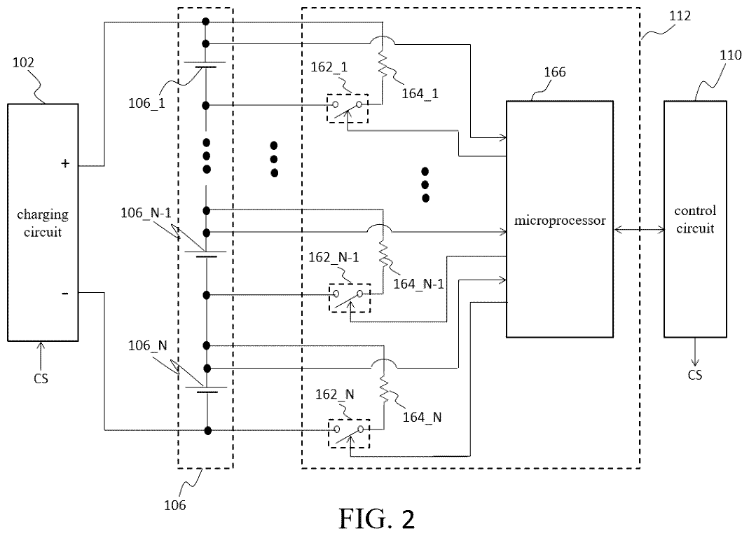

FIG. 2 shows the electrical coupling relationship between the charging device and the battery pack 106. Please refer to FIG. 2. In this embodiment, the battery pack 106 consists of a battery string, and the battery string consists of batteries (as indicated by labels 106_1 to 106_N, where N is a natural number) connected in series. In addition, the charging circuit 102, the battery balancing circuit 112 and the control circuit 110 make up the aforementioned charging device. The charging circuit 102 is electrically coupled to two terminals of the battery string. The battery balancing circuit 112 is electrically coupled to the two terminals of each battery, for measuring a voltage of each battery, and for performing a voltage balancing operation on the battery string. The control circuit 110 is electrically coupled to the charging circuit 102 and the battery balancing circuit 112 to control their operations. In this embodiment, the control circuit 110 uses a control signal CS to control the operation of the charging circuit 102.

In this embodiment, the battery balancing circuit 112 comprises switches 162_1-162_N, resistors 164_1-164_N and a microprocessor 166. As shown in FIG. 2, one terminal of each resistor is electrically coupled to the positive terminal of one of the batteries, and the other terminal of each resistor is electrically coupled to the negative terminal of one of the batteries through one of the switches. In addition, the microprocessor 166 is electrically coupled to the positive terminal of each battery for voltage measurement. The microprocessor 166 is also electrically coupled to the control terminal of each switch to control the operations of the switches. The microprocessor 166 can also transmit the measured voltage values to the control circuit 110, so that the control circuit 110 can determine the charging status of each battery accordingly.

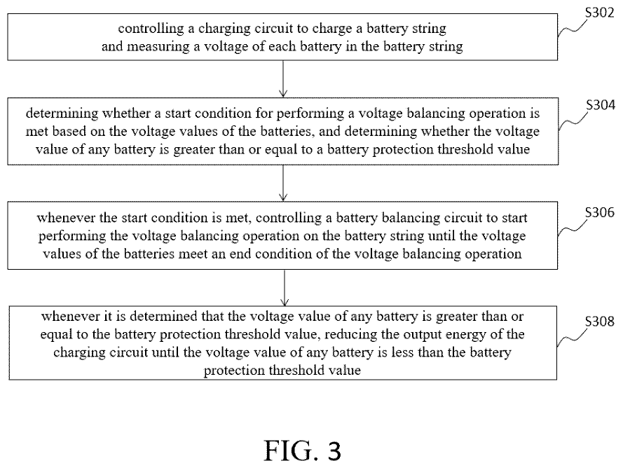

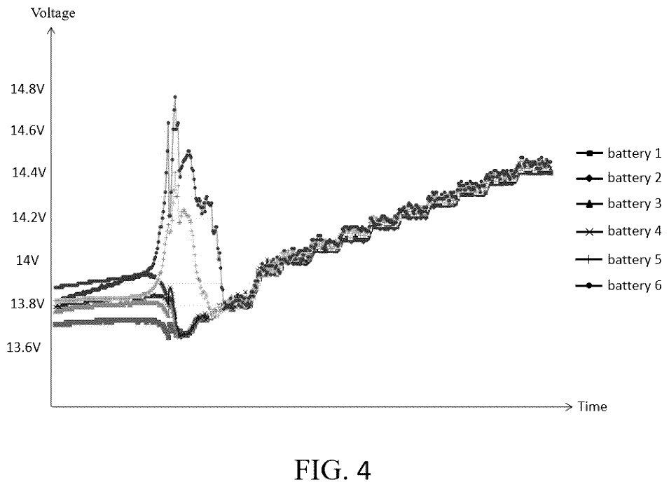

FIG. 3 is a flow chart of a charging method according to an embodiment of the present invention. Please refer to FIGS. 2-3. In this method, the control circuit 110 first controls the charging circuit 102 to charge the battery string (consisting of batteries 106_1-106_N connected in series), and controls the battery balancing circuit 112 to measure a voltage of each battery (as shown in step S302). To facilitate understanding, the following uses a battery string with 6 batteries as an example. FIG. 4 is used to illustrate one of the charging processes of the aforementioned battery string. Please also refer to FIGS. 2-4. Assuming that the charging circuit 102 operates in a constant voltage charging mode, in this embodiment, the control circuit 110 controls the charging circuit 102 to first output an initial target voltage to start charging the battery string. The value of the initial target voltage is a product of the number of the batteries 106_1-106_N and a standard charging voltage defined by the specification of the batteries 106_1-106_N. The aforementioned batteries may all be lead-acid batteries or all lithium batteries. Assuming that the aforementioned batteries are lead-acid batteries, the aforementioned standard charging voltage is a standby use charging voltage defined by the specification of the lead-acid batteries. The standby use charging voltage is also called float use charging voltage. In this embodiment, the initial target voltage is 13.8V.

Next, the control circuit 110 determines whether a start condition for performing the voltage balancing operation is met based on the voltage values of the batteries, and determines whether the voltage value of any battery is greater than or equal to a battery protection threshold value (as shown in step S304). There are two kinds of start condition, and which start condition is adopted can be decided according to actual design requirements. The first kind of the start condition is that the voltage difference between the voltage of any battery and the average voltage of the batteries is greater than or equal to a threshold value ^{Δ}Vs, while the second kind of the start condition is that the voltage difference between any two batteries is greater than or equal to the threshold value ^{Δ}Vs. The threshold value ^{Δ}Vs can be determined according to actual design requirements. In this embodiment, the threshold value ΔVs is 0.1V. In addition, the battery protection threshold value is also determined based on actual design requirements. In this embodiment, the battery protection threshold value is 14.6V.

Afterwards, whenever it is determined that the start condition is met, the control circuit 110 controls the battery balancing circuit 112 to start performing the voltage balancing operation on the battery string until the voltage values of the batteries meet an end condition of the voltage balancing operation (as shown in step S306), and whenever it is determined that the voltage value of any battery is greater than or equal to the battery protection threshold value, the control circuit 110 reduces the output energy of the charging circuit 102 until the voltage value of any battery is less than the battery protection threshold value (as shown in step S308). Since steps S306 and S308 have respective execution conditions, there is no order of execution of steps S306 and S308.

As can be seen from FIG. 4, after the battery string is charged for a period of time, the voltages of the batteries become unbalanced. Therefore, the control circuit 110 controls the battery balancing circuit 112 to start performing the voltage balancing operation on the battery string. It can also be seen from FIG. 4 that during the voltage balancing operation, the voltage value of battery 6 exceeds the battery protection threshold value (i.e., 14.6V). At this time, the control circuit 110 reduces the output energy of the charging circuit 102 until the voltage value of any battery is less than the battery protection threshold value. Since the charging circuit 102 in this embodiment operates in constant voltage charging mode, in this embodiment, the control circuit 110 reduces the output energy of the charging circuit 102 by reducing the output voltage of the charging circuit 102. For example, the output voltage of the charging circuit 102 is reduced by a predetermined value, a predetermined ratio, or even reduced to 0V.

It can also be seen from FIG. 4 that since the output energy of the charging circuit 102 is reduced, the voltage values of some batteries begin to drop sharply, making the voltage value of each battery less than the battery protection threshold value (i.e., 14.6V). In addition, as the voltage balancing operation proceeds, the voltage values of the batteries become more and more consistent. Certainly, the control circuit 110 can also dynamically adjust the output voltage of the charging circuit 102. For example, control circuit 110 reduces the output voltage of the charging circuit 102 as long as the voltage value of any battery is greater than or equal to the battery protection threshold value, and increases the output voltage of the charging circuit 102 as long as the voltage values of all batteries are less than the battery protection threshold value.

As the voltage balancing operation proceeds, the control circuit 110 also periodically or irregularly determines whether the voltage values of the batteries meet the end condition of the voltage balancing operation. There are two kinds of end condition, and which end condition is adopted can be decided according to actual design requirements. The first kind of the end condition is that the voltage difference between the voltage of any battery and the average voltage of the batteries is less than a threshold value Vb, while the second kind of the end condition is that the voltage difference between any two batteries is less than the threshold value Vb. The threshold value Vb can be determined according to actual design requirements, but the threshold value Vb should be less than the threshold value ^{Δ}Vs. In this embodiment, the threshold value Vb is 0.05V.

As can be seen from FIG. 4, after the voltage balancing operation is performed for a period of time, the voltage values of the batteries in the battery string gradually become consistent. When the voltage values of the batteries meet the end condition of the voltage balancing operation, the control circuit 110 increases the output voltage of the charging circuit 102 to the maximum target voltage, so that the charging circuit 102 can continue charging the battery string accordingly. The maximum target voltage is greater than the aforementioned initial target voltage. The value of the maximum target voltage is a product of the number of the batteries 106_1-106_N and a maximum chargeable voltage defined by the specification of the batteries 106_1-106_N. Assuming that the aforementioned batteries are lead-acid batteries, the aforementioned maximum chargeable voltage is a cycle use charging voltage defined by the specification of the lead-acid batteries. In this embodiment, the maximum target voltage is 14.4V.

As shown in FIG. 4, in this embodiment, the control circuit 110 progressively increases the output voltage of the charging circuit 102 to the maximum target voltage of 14.4V. In addition, when the end condition of the voltage balancing operation is met, the control circuit 110 can still control the battery balancing circuit 112 to continue to perform the voltage balancing operation on the battery string, so that the voltages of the batteries can still maintain balanced during the period when the output voltage of the charging circuit 102 gradually increases to the maximum target voltage.

Certainly, when the end condition of the voltage balancing operation is met, the control circuit 110 can also control the battery balancing circuit 112 to stop performing the voltage balancing operation. However, the drawback of doing so is that the voltages of the batteries may not maintain balanced during the period when the output voltage of the charging circuit 102 gradually increases to the maximum target voltage. In addition, the control circuit 110 may not use the aforementioned incremental manner to increase the output voltage of the charging circuit 102 to the maximum target voltage, but rather control the charging circuit 102 to directly pull up the output voltage to the maximum target voltage. Furthermore, during the process of charging the battery string, the control circuit 110 may also control the charging circuit 102 to use the maximum target voltage throughout the entire process to charge the battery string.

Although in the foregoing embodiments, the charging circuit 102 operates in the constant voltage charging mode, this is not intended to limit the present invention. For example, the charging circuit 102 may also operate in a constant current charging mode. If the charging circuit 102 operates in the constant current charging mode, the control circuit 110 can change the output energy of the charging circuit 102 by adjusting the output current of the charging circuit 102, so that the voltage of the battery string can reach the aforementioned initial target voltage and the aforementioned maximum target voltage. For example, when the end condition of the voltage balancing operation is met, the control circuit 120 can increase the output current of the charging circuit 102, so that the charging circuit 102 can continue charging the battery string accordingly and thereby making the voltage of the battery string rises to the maximum target voltage.

The control circuit 110 may increase the output current of the charging circuit 102 in an incremental manner, thereby increasing the voltage of the battery string to the maximum target voltage. Certainly, the control circuit 110 may not use the incremental manner to increase the output current of the charging circuit 102, but rather control the charging circuit 102 to directly pull up the output current to a predetermined value, thereby making the voltage of the battery string to be directly pulled up to the maximum target voltage. In addition, during the process of charging the battery string, the control circuit 110 may also control the charging circuit 102 to use the predetermined value of the output current throughout the entire process to charge the battery string. Furthermore, as mentioned above, once the control circuit 110 needs to reduce the output energy of the charging circuit 102, it can do so by reducing the output current of the charging circuit 102.

In addition, although in the above embodiments, the battery pack 106 consists of a battery string, this is not intended to limit the invention. Those skilled in the art should know that the battery pack 106 can consist of at least two battery strings connected in parallel.

Based on the above teachings, it can be seen that through the voltage balancing operation and the setting of the battery protection threshold value, the present invention can effectively prevent every single battery from being overcharged. In addition, since no battery will be overcharged, the present invention can further shorten the time required for the voltage balancing operation. Furthermore, by setting the maximum target voltage, the present invention can also increase the endurance of every single battery.

In addition, based on the above teachings, skilled in the art should know that the concept of the present invention can also be applied to other uninterruptible power systems with different architectures, please refer to the following description.

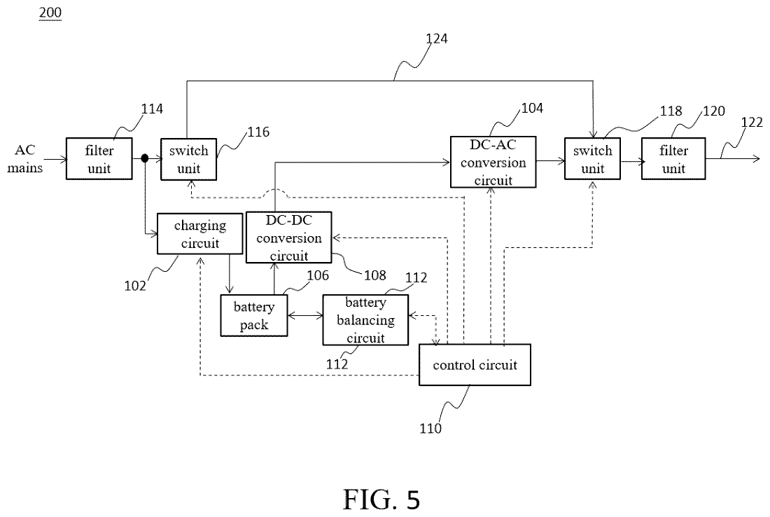

FIG. 5 shows an uninterruptible power system according to another embodiment of the present invention. Please refer to FIG. 5. From the circuit structure shown in FIG. 5, it can be seen that the uninterruptible power system 200 is an off-line uninterruptible power system. Compared with the off-line uninterruptible power system shown in FIG. 1, the off-line uninterruptible power system shown in FIG. 5 further comprises a DC-DC conversion circuit 108. The DC-DC conversion circuit 108 is electrically coupled between the battery pack 106 and the input terminal of the DC-AC conversion circuit 104, and is electrically coupled to the control circuit 110 to be controlled by the control circuit 110.

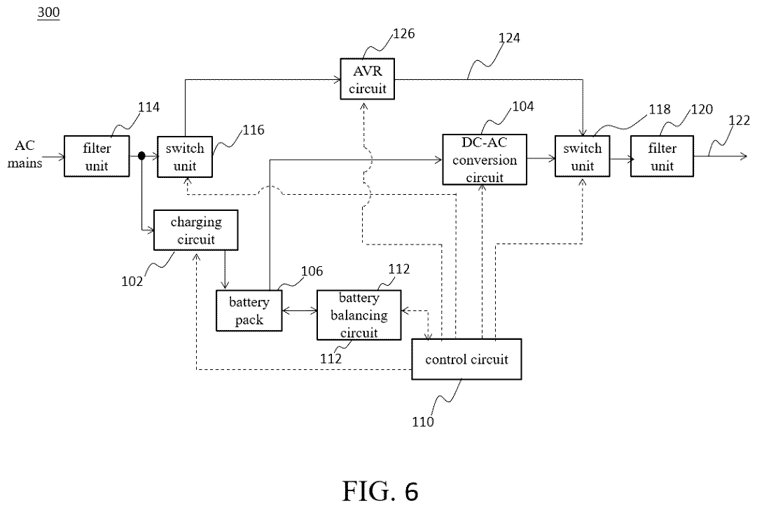

FIG. 6 shows an uninterruptible power system according to still another embodiment of the present invention. Please refer to FIG. 6. From the circuit structure shown in FIG. 6, it can be seen that the uninterruptible power system 300 is a line-interactive uninterruptible power system. Compared with the off-line uninterruptible power system shown in FIG. 1, the line-interactive uninterruptible power system shown in FIG. 6 further comprises an automatic voltage regulation circuit (AVR circuit) 126. The automatic voltage regulation circuit 126 is disposed on the bypass path 124, and is electrically coupled to the control circuit 110 to be controlled by the control circuit 110.

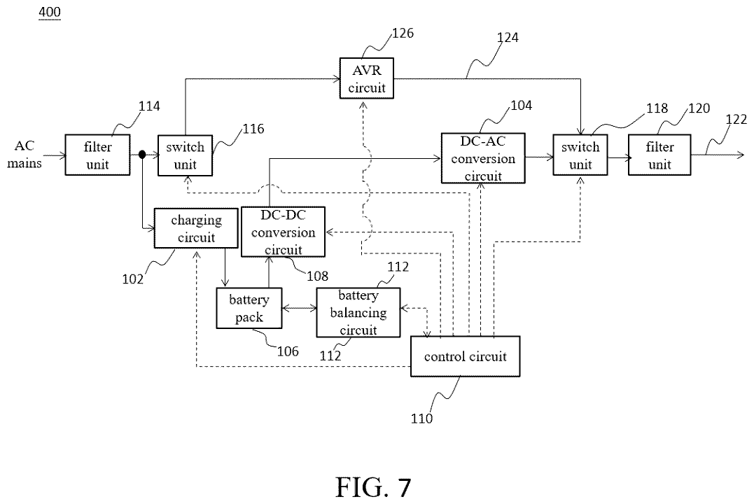

FIG. 7 shows an uninterruptible power system according to still another embodiment of the present invention. Please refer to FIG. 7. From the circuit structure shown in FIG. 7, it can be seen that the uninterruptible power system 400 is a line-interactive uninterruptible power system. Compared with the line-interactive uninterruptible power system shown in FIG. 6, the line-interactive uninterruptible power system shown in FIG. 7 further comprises a DC-DC conversion circuit 108. The DC-DC conversion circuit 108 is electrically coupled between the battery pack 106 and the input end of the DC-AC conversion circuit 104, and is electrically coupled to the control circuit 110 to be controlled by the control circuit 110.

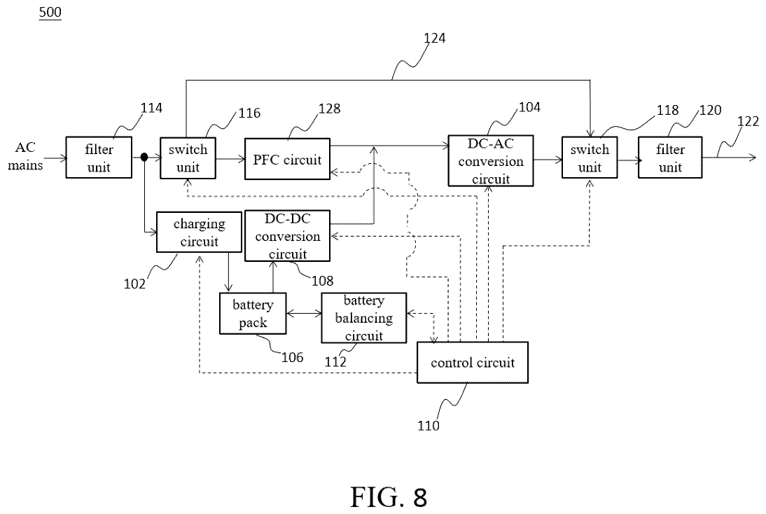

FIG. 8 shows an uninterruptible power system according to still another embodiment of the present invention. Please refer to FIG. 8. From the circuit structure shown in FIG. 8, it can be seen that the uninterruptible power system 500 is an on-line uninterruptible power system. Compared with the off-line uninterruptible power system shown in FIG. 5, the on-line uninterruptible power system shown in FIG. 8 further comprises a power factor correction circuit (PFC circuit) 128. The power factor correction circuit 128 is electrically coupled between the switch unit 116 and the input terminal of the DC-AC conversion circuit 104, and is electrically coupled to the control circuit 110 to be controlled by the control circuit 110. In addition, in this embodiment, the control circuit 110 can control the operation of the switch unit 116, so as to determine whether to electrically couple the filter unit 114 to the bypass path 124, or to electrically couple the filter unit 114 to the input terminal of the power factor correction circuit 128.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A charging method, suitable for a battery string consisting of batteries connected in series, comprising the following steps:
controlling a charging circuit to charge the battery string and measuring a voltage of each battery;
determining whether a start condition for performing a voltage balancing operation is met based on the voltage values of the batteries, and determine whether the voltage value of any battery is greater than or equal to a first threshold value;
whenever the start condition is met, controlling a battery balancing circuit to start performing the voltage balancing operation on the battery string until the voltage values of the batteries meet an end condition of the voltage balancing operation; and
whenever it is determined that the voltage value of any battery is greater than or equal to the first threshold value, reducing the output energy of the charging circuit until the voltage value of any battery is less than the first threshold value.

2. The charging method as claimed in claim 1, further comprising the steps of: reducing the output energy of the charging circuit by reducing the output voltage of the charging circuit.

3. The charging method as claimed in claim 2, further comprising the steps of: when the end condition is met, increasing the output voltage of the charging circuit to a maximum target voltage, and continuing charging the battery string accordingly, wherein the maximum target voltage is greater than an initial target voltage of the charging circuit, the value of the maximum target voltage is a product of the number of the batteries and a maximum chargeable voltage defined by the specification of the batteries, and the value of the initial target voltage is a product of the number of the batteries and a standard charging voltage defined by the specification of the batteries.

4. The charging method as claimed in claim 3, further comprising the steps of: progressively increasing the output voltage of the charging circuit to the maximum target voltage.

5. The charging method as claimed in claim 3, further comprising the steps of: when the end condition is met, controlling the battery balancing circuit to continue to perform the voltage balancing operation on the battery string.

6. The charging method as claimed in claim 3, wherein the batteries are lead-acid batteries, the maximum chargeable voltage is a cycle use charging voltage defined by the specification of the batteries, and the standard charging voltage is a standby use charging voltage defined by the specification of the batteries.

7. The charging method as claimed in claim 3, wherein the batteries are lithium batteries.

8. The charging method as claimed in claim 1, further comprising the steps of: reducing the output energy of the charging circuit by reducing the output current of the charging circuit.

9. The charging method as claimed in claim 8, further comprising the steps of: when the end condition is met, increasing the output current of the charging circuit, so that the charging circuit can continue charging the battery string accordingly and thereby making the voltage of the battery string rises to a maximum target voltage, wherein the maximum target voltage is greater than an initial target voltage of the charging circuit, the value of the maximum target voltage is a product of the number of the batteries and a maximum chargeable voltage defined by the specification of the batteries, and the value of the initial target voltage is a product of the number of the batteries and a standard charging voltage defined by the specification of the batteries.

10. The charging method as claimed in claim 9, further comprising the steps of: progressively increasing the output current of the charging circuit, thereby progressively increasing the voltage of the battery string to the maximum target voltage.

11. The charging method as claimed in claim 9, further comprising the steps of: when the end condition is met, controlling the battery balancing circuit to continue to perform the voltage balancing operation on the battery string.

12. The charging method as claimed in claim 9, wherein the batteries are lead-acid batteries, the maximum chargeable voltage is a cycle use charging voltage defined by the specification of the batteries, and the standard charging voltage is a standby use charging voltage defined by the specification of the batteries.

13. The charging method as claimed in claim 9, wherein the batteries are lithium batteries.

14. The charging method as claimed in claim 1, wherein the start condition is that the voltage difference between the voltage of any battery and the average voltage of the batteries is greater than or equal to a second threshold value, and the end condition is that the voltage difference between the voltage of any battery and the average voltage of the batteries is less than a third threshold value, wherein the third threshold value is less than the second threshold value.

15. The charging method as claimed in claim 1, wherein the start condition is that the voltage difference between any two batteries is greater than or equal to a second threshold value, and the end condition is that the voltage difference between any two batteries is less than a third threshold value, wherein the third threshold value is less than the second threshold value.

16. A charging device, used for charging a battery string consisting of batteries connected in series, the charging device comprising:
a charging circuit, electrically coupled to two terminals of the battery string;
a battery balancing circuit, electrically coupled to the two terminals of each battery, for measuring a voltage of each battery and performing a voltage balancing operation on the battery string; and
a control circuit, electrically coupled to the charging circuit and the battery balancing circuit, the control circuit being used to control the charging circuit to charge the battery string, and to control the battery balancing circuit to measure the voltage of each battery, the control circuit being also used to determine whether a start condition for performing the voltage balancing operation is met based on the voltage values of the batteries, and to determine whether the voltage value of any battery is greater than or equal to a first threshold value, wherein whenever the start condition is met, the control circuit controls the battery balancing circuit to start performing the voltage balancing operation on the battery string until the voltage values of the batteries meet an end condition of the voltage balancing operation, and whenever it is determined that the voltage value of any battery is greater than or equal to the first threshold value, the control circuit reduces the output energy of the charging circuit until the voltage value of any battery is less than the first threshold value.

17. The charging device as claimed in claim 16, wherein the control circuit comprises reducing the output energy of the charging circuit by reducing the output voltage of the charging circuit.

18. The charging device as claimed in claim 17, wherein when it is determined that the end condition is met, the control circuit increases the output voltage of the charging circuit to a maximum target voltage, so that the charging circuit can continue charging the battery string accordingly, wherein the maximum target voltage is greater than an initial target voltage of the charging circuit, the value of the maximum target voltage is a product of the number of the batteries and a maximum chargeable voltage defined by the specification of the batteries, and the value of the initial target voltage is a product of the number of the batteries and a standard charging voltage defined by the specification of the batteries.

19. The charging device as claimed in claim 18, wherein the control circuit comprises progressively increasing the output voltage of the charging circuit to the maximum target voltage.

20. The charging device as claimed in claim 18, wherein when it is determined that the end condition is met, the control circuit further controls the battery balancing circuit to continue to perform the voltage balancing operation on the battery string.

21. The charging device as claimed in claim 18, wherein the batteries are lead-acid batteries, the maximum chargeable voltage is a cycle use charging voltage defined by the specification of the batteries, and the standard charging voltage is a standby use charging voltage defined by the specification of the batteries.

22. The charging device as claimed in claim 18, wherein the batteries are lithium batteries.

23. The charging device as claimed in claim 16, wherein the control circuit comprises reducing the output energy of the charging circuit by reducing the output current of the charging circuit.

24. The charging device as claimed in claim 23, wherein when the end condition is met, the control circuit increases the output current of the charging circuit, so that the charging circuit can continue charging the battery string accordingly and thereby making the voltage of the battery string rises to a maximum target voltage, wherein the maximum target voltage is greater than an initial target voltage of the charging circuit, the value of the maximum target voltage is a product of the number of the batteries and a maximum chargeable voltage defined by the specification of the batteries, and the value of the initial target voltage is a product of the number of the batteries and a standard charging voltage defined by the specification of the batteries.

25. The charging device as claimed in claim 24, wherein the control circuit comprises progressively increasing the output current of the charging circuit, thereby progressively increasing the voltage of the battery string to the maximum target voltage.

26. The charging device as claimed in claim 24, wherein when it is determined that the end condition is met, the control circuit further controls the battery balancing circuit to continue to perform the voltage balancing operation on the battery string.

27. The charging device as claimed in claim 24, wherein the batteries are lead-acid batteries, the maximum chargeable voltage is a cycle use charging voltage defined by the specification of the batteries, and the standard charging voltage is a standby use charging voltage defined by the specification of the batteries.

28. The charging device as claimed in claim 24, wherein the batteries are lithium batteries.

29. The charging device as claimed in claim 16, wherein the start condition is that the voltage difference between the voltage of any battery and the average voltage of the batteries is greater than or equal to a second threshold value, and the end condition is that the voltage difference between the voltage of any battery and the average voltage of the batteries is less than a third threshold value, wherein the third threshold value is less than the second threshold value.

30. The charging device as claimed in claim 16, wherein the start condition is that the voltage difference between any two batteries is greater than or equal to a second threshold value, and the end condition is that the voltage difference between any two batteries is less than a third threshold value, wherein the third threshold value is less than the second threshold value.

31. An on-line uninterruptible power system, which adopts the charging device as claimed in claim 16.

32. An off-line uninterruptible power system, which adopts the charging device as claimed in claim 16.

33. A line-interactive uninterruptible power system, which adopts the charging device as claimed in claim 16.
